(19) United States
(12) Patent Application Publication
(10) Pub. No.: US 2006/0251013 A1
(43) Pub. Date: Nov. 9, 2006

(54) Resource allocation in multi-access point wireless networks

(75) Inventors: Vincent Roy, Montreal (CA); Paul Marinier, Brossard (CA); Christopher Cave, Candiac (CA); Angelo Cuffaro, Laval (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/143,346

(22) Filed: Jun. 2, 2005

Related U.S. Application Data
(60) Provisional application No. 60/677,561, filed on May 4, 2005.

(51) Int. Cl. H04Q 7/00

(52) U.S. Cl. 370/329

(57) ABSTRACT

Methods for sharing radio resource allocation information between access points (APs) in a wireless local area network include: sending resource allocation information from a first AP to at least one other AP; directly requesting resource allocation information from a first AP by a second AP; or requesting resource allocation information for a first AP by a second AP through a centralized entity. A similar method may also be used to allocate radio resources among APs.

### CROSS REFERENCE TO RELATED APPLICATION(S)

This application claims the benefit of U.S. Provisional Application No. 60/677,561, filed on May 4, 2005, which is incorporated by reference as if fully set forth herein.

### FIELD OF INVENTION

The present invention relates generally to wireless local area networks (WLANs), and more particularly, to methods for allocating radio resources in a WLAN.

### BACKGROUND

WLAN systems and standards such as IEEE 802.11 and 802.11b were originally designed to be best effort and to ensure fairness among all users in accessing the wireless medium. This meant that little consideration was put on providing the means by which quality of service (QoS) could be guaranteed to users or by which the differences between QoS requirements of each user could be considered. As the desire for using WLAN systems to support QoS-driven applications (such as Voice Over IP (VoIP) and real-time video applications) grew, standardization bodies such as 802.11e were formed to address the issue.

The 802.11e standard includes the required mechanisms and signaling by which an AP and its STA exchange information about the user's application requirements and the AP's ability to allocate the required radio resources to the STA. In other words, 802.11e standardized the mechanisms that allow one AP to allocate radio resources to STAs in a manner that would aim at delivering the respective QoS required by each STA.

What the standard has not considered is a system that consists of multiple co-channel APs deployed in such proximity that they would share the wireless medium. In such scenario, it is not sufficient for an AP receiving a radio resource allocation request from a STA to only consider the radio resources it has already allocated to the STAs that are associated to that AP. Doing so would result in having multiple APs allocating the same radio resources to different STAs, which would defeat the purpose of radio resource allocation and would translate into poor QoS for all STAs sharing the channel.

### SUMMARY

This invention circumvents the problem described above by providing the mechanisms and signaling by which resource allocation information can be shared among APs and by which an access controller (AC) can signal and allocate radio resources among APs. It includes methods and signaling that can be implemented in an AP, an AC, and a non-AP station (STA), by which APs can share information related to radio resource allocation between themselves and by which the AC signals and allocates radio resources between APs.

A method for sharing radio resource allocation information between APs in a WLAN includes the step of sending resource allocation information from a first AP to at least one other AP.

A second method for sharing radio resource allocation information between APs in a WLAN begins by requesting resource allocation information by a first AP from a second AP. The second AP responds to the request by sending resource allocation information to the first AP.

A third method for sharing radio resource allocation information between APs in a WLAN begins by reporting resource allocation information from a first AP to a centralized entity. Resource allocation information for the first AP is requested by a second AP, the second AP querying the centralized entity. The resource allocation information for the first AP is sent from the centralized entity to the second AP.

A fourth method for sharing radio resource allocation information between APs in a WLAN begins by reporting resource allocation information from a first AP to a centralized entity. Resource allocation information for the first AP is relayed to at least one other AP.

A method for an access controller (AC) to allocate radio resources among APs in a wireless local area network begins by reporting radio resource information from a first AP to the AC. Radio resources are requested by a second AP from the AC, and the AC responds to the radio resources request.

### BRIEF DESCRIPTION OF THE DRAWINGS

A more detailed understanding of the invention may be had from the following description of a preferred embodiment, given by way of example, and to be understood in conjunction with the accompanying drawings, wherein:

FIG. 1 is a flow diagram of a method for an AP to broadcast its radio resource allocation information;

FIG. 2 is a flow diagram of a method for an AP to request resource allocation information from another AP;

FIG. 3 is a flow diagram of a method using a centralized entity to manage resource allocation information;

FIG. 4 is a flow diagram of a second method using a centralized entity to manage resource allocation information; and

FIG. 5 is a flow diagram of a method using an AC to respond to a resource allocation request.

### DETAILED DESCRIPTION OF THE PREFERRED EMBODIMENTS

Hereafter, the term “station” (STA) includes, but is not limited to, a wireless transmit/receive unit (WTRU), a user equipment, a fixed or mobile subscriber unit, a pager, or any other type of device capable of operating in a wireless environment. When referred to hereafter, the term “access point” (AP) includes, but is not limited to, a base station, a Node B, a site controller, or any other type of interfacing device in a wireless environment.

Radio Resource Allocation Information Shared Between APs

Generally, the resource allocation information that is shared between APs includes, but is not limited to:

(1) The list of STAs served by an AP, using unique identifiers to distinguish STAs from each other in the whole system. An example of such a unique identifier is the MAC address of the STA.

(2) The radio resources that have been allocated to each STA. An example of measures that can be used to express allocated radio resources include allocated time units.

(3) The frequency channel used by an AP and its associated STA.

(4) The path loss between two APs, and/or the minimum path loss between a STA associated to an AP and another AP, if available.

(5) The list of neighboring APs that share the same medium as the AP, if available. Two APs share the same medium if they use the same frequency channel and if a certain proximity criterion is met. One example of a proximity criterion is if at least one STA (AP or non-AP) from the BSS served by one AP can hear above a certain threshold the signal transmitted by at least one STA (AP or non-AP) from the BSS served by the other AP. This information can be obtained from reports from STAs and/or be directly measured at the AP.

(6) The radio resources that are used by each STA. Examples of measures that can be used to express used radio resources include used time units or a ratio (fraction or percentage) of used versus allocated radio resources.

(7) The aggregated radio resources that an AP has allocated per access category and/or total aggregated radio resources allocated by an AP.

(8) The aggregated radio resources that have been allocated and/or used per access category in a given Basic Service Set (BSS) and/or total aggregated radio resources used in a BSS.

(9) The quality experienced by each STA. Examples of measures that can be used to express the quality experienced by STAs include time jitter, time latency, packet error rate, throughput, queued time, etc.

(10) The QoS Configuration Parameters used by the AP. For example, in a carrier sense multiple access (CSMA) scheme, this could correspond to the different enhanced distributed channel access (EDCA) parameter sets that the AP uses for each QoS class (in 802.11, QoS classes are called Access Categories). The parameters defining the EDCA QoS policy, such as the minimum idle delay before contention (the arbitration interframe space (AIFS)), the minimum and maximum contention windows (CWmin and CWmax), and the transmit opportunity (TXOP) limit parameters can be different for each Access Category within an AP. The information can also include, but it is not limited to, pre-determined rules that would allow two different APs to synchronize their QoS policies. Examples of such rules include:

i. Two APs sharing the same medium will use the EDCA parameter set of the AP that has the most discriminatory QoS policies (i.e., the one with the greatest differences in the EDCA parameter set between QoS Access Categories).

ii. Two APs sharing the same medium will use the EDCA parameter set of the AP that has been active the longest.

iii. Two APs sharing the same medium will use the EDCA parameter set of the AP that supports the most traffic.

It is noted that the above rules are exemplary, and that one skilled in the art can readily create additional rules for synchronizing the QoS policies between two APs.

Methods for Sharing Radio Resource Allocation Information Between APs

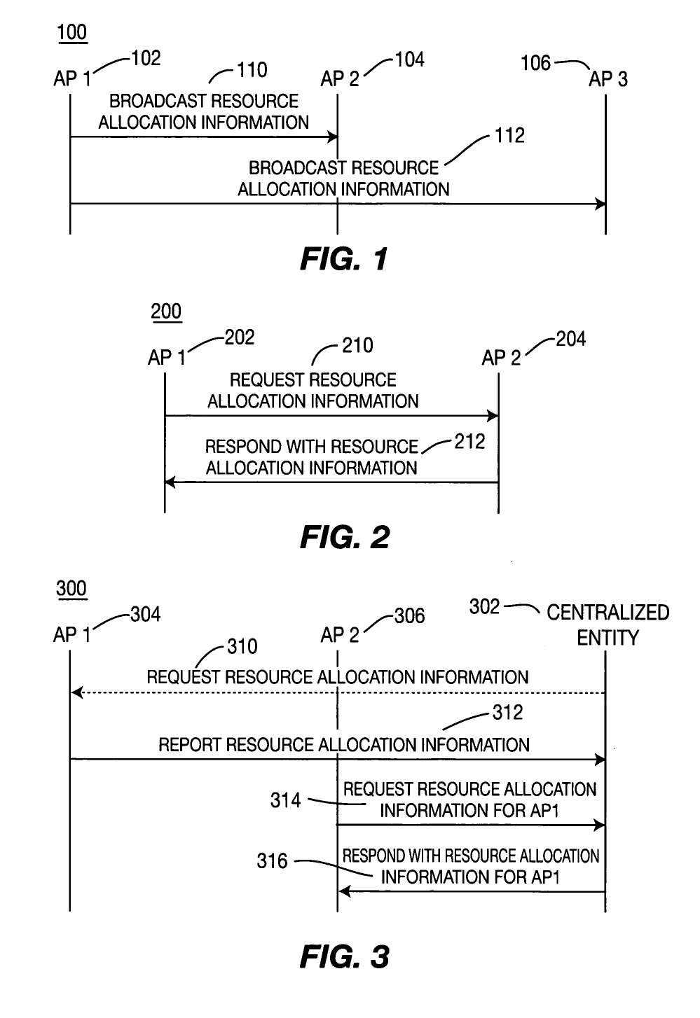

FIG. 1 is a flow diagram of a method 100 for a first AP (AP1) 102 to broadcast its radio resource allocation information to other APs (AP2, AP3) 104, 106. AP1 102 broadcasts its resource allocation information to AP2 104 (step 110) and to AP3 106 (step 112).

AP1 102 can broadcast the resource allocation information over the wireless medium using management frames, control frames, or as the payload of a data frame; or broadcast over the distribution system using inter-AP communication protocol. It is noted that AP1 102 can unicast the information either individually to AP2 104 and AP3 106, by a multicast to a group of APs, or by a group broadcast to all available APs.

FIG. 2 is a flow diagram of a method 200 for an AP (AP1) 202 to request resource allocation information from another AP (AP2) 204. AP1 202 requests resource allocation information from AP2 204 (step 210). AP2 responds to the request by sending its resource allocation information to AP1 202 (step 212).

Both the request (step 210) and the response (step 212) can be performed using management frames, control frames, or as the payload of a data frame; or broadcast over the distribution system using inter-AP communication protocol.

FIG. 3 is a flow diagram of a method 300 using a centralized entity to collect, store, and distribute resource allocation information. A centralized entity 302 requests resource allocation information from an AP (AP1) 304 (step 310). The centralized entity 302 can include any type of centrally located entity, such as a database, a smart node, or a dumb node. One skilled in the art could readily envision other types of centralized entities that would operate in the same manner. In one embodiment, the centralized entity 302 is located on a server, such that it can contain resource allocation information for any STA in any BSS. It is noted that step 310 is an optional step, and the method 300 would operate in the same manner if step 310 was eliminated.

AP1 304 reports its resource allocation information to the centralized entity 302 (step 312). AP1 304 reports the resource allocation information for all of its associated STAs to the centralized entity 302. A second AP (AP2) 306 requests resource allocation information from the centralized entity 302 for AP1 304 (step 314). The centralized entity 302 responds to the request by sending the resource allocation information for AP1 304 to AP2 306 (step 316).

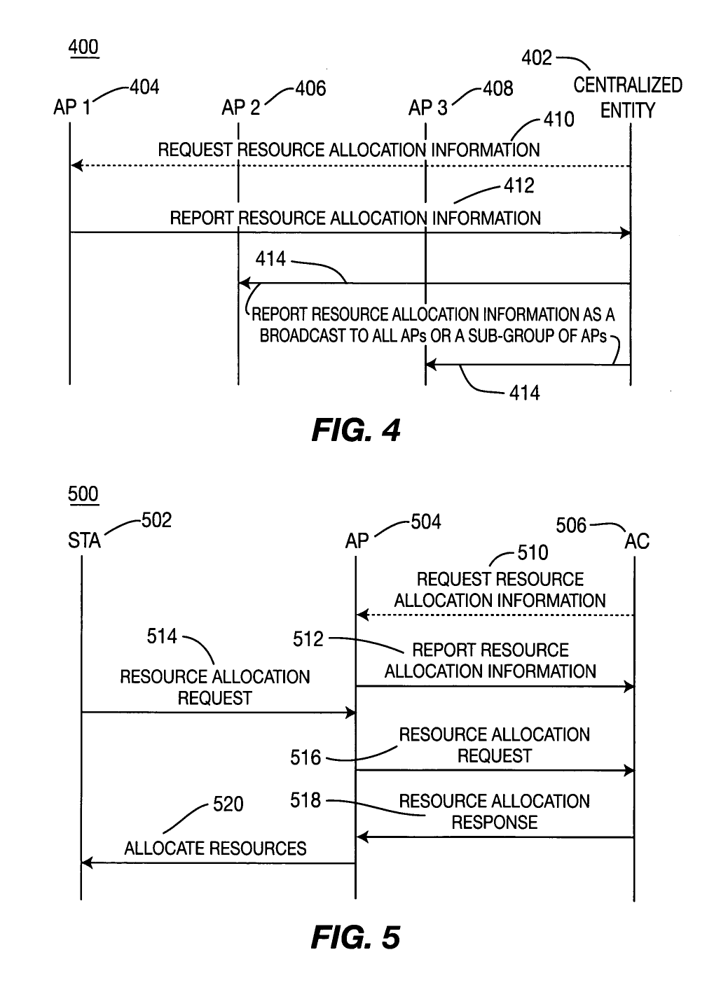

FIG. 4 is a flow diagram of a method 400 using a centralized entity to collect, store, and distribute resource allocation information. A centralized entity 402 requests resource allocation information from an AP (AP1) 404 (step 410). It is noted that step 410 is an optional step, and the method 400 would operate in the same manner if step 410 was eliminated. AP1 404 reports its resource allocation information to the centralized entity 402 (step 412). The centralized entity 402 reports the resource allocation information for AP1 404 to other APs in the network (AP2 406 and AP3 408; step 414). The reporting can be by a broadcast to all APs on the network, or to a subgroup of APs in the network.

In addition, the centralized entity 402 can send the resource allocation information relative to a given BSS only to the APs sharing the wireless medium with that BSS or to the APs that have STAs sharing the wireless medium with that BSS. This can be achieved by having the STA reporting to the AP the WLAN nodes it can hear (above its deferring threshold) and having the AP report this information back to the centralized entity as well as the list of the WLAN nodes that the AP can hear.

Signaling and Allocating Radio Resources Among APs by an AC

Implementing centralized decision-making where an access controller (AC) manages the radio resource allocation among co-channel BSSs can assist in preventing APs that share the wireless medium from allocating more radio resources than the channel can support.

A method 500 for using an AC to respond to a resource allocation request is shown in FIG. 5. The method 500 utilizes a STA 502, an AP 504, and an AC 506 and begins with the AC 506 requesting resource allocation information from the AP 504 (step 510). It is noted that step 510 is an optional step, and the method 500 would operate in the same manner if step 510 was eliminated. AP 504 reports its resource allocation information to the AC 506 (step 512). The STA 502 requests resources from the AP 504 (step 514). One example of step 514 in an 802.11e-compliant WLAN system would include the STA 502 sending an ADDTS frame to the AP 504.

The AP 504 makes a resource allocation request to the AC 506 (step 516). The resource allocation request can include the AP 504 requesting a certain allocated time budget based upon an association request it has received from the STA 502 (in step 514), or the AP 504 requesting the amount of radio resources it is allowed to allocate. The resource allocation can also include the AP 504 forwarding, partially or entirely, the information contained in the resource allocation request received from the STA 502.

The AC 506 then determines whether to accept or reject the resource allocation request from the AP 504. This determination is achieved by the AC 506 analyzing resource allocation information collected from the different APs and verifying if the added resource allocation would allow the system to offer satisfactory QoS to the STA 502 and to all nodes that share the wireless medium with the STA 502 and the AP 504. The AC 506 replies to the AP 504 with a resource allocation response (step 518). When the AC 506 responds to the allocation request from the AP 504, the AC can accept or reject the resource allocation request from the AP 504 or provide a resources budget (e.g., an allocated time budget) to the AP 504 periodically or after the AC has been prompted for one (as shown in step 516). Depending on the resource allocation response that the AP 504 receives from the AC 506, the AP 504 responds to the resource allocation request sent by the STA 502 and allocates resources to the STA 502 (step 520).

Although the features and elements of the present invention are described in the preferred embodiments in particular combinations, each feature or element can be used alone (without the other features and elements of the preferred embodiments) or in various combinations with or without other features and elements of the present invention.

What is claimed is:

1. A method for sharing radio resource allocation information between access points (APs) in a wireless local area network, comprising the step of:
sending resource allocation information from a first AP to at least one other AP.

2. The method according to claim 1, wherein the sending step is performed by broadcasting management frames.

3. The method according to claim 1, wherein the sending step is performed by broadcasting control frames.

4. The method according to claim 1, wherein the sending step is performed by sending the resource allocation information as a payload of a data frame.

5. The method according to claim 1, wherein the sending step is performed by using an inter-AP communication protocol.

6. A method for sharing radio resource allocation information between access points (APs) in a wireless local area network, comprising the steps of:
requesting resource allocation information by a first AP from a second AP; and
responding to the request by the second AP sending resource allocation information to the first AP.

7. The method according to claim 6, wherein the responding step is performed by broadcasting management frames.

8. The method according to claim 6, wherein the responding step is performed by broadcasting control frames.

9. The method according to claim 6, wherein the responding step is performed by sending the resource allocation information as a payload of a data frame.

10. The method according to claim 6, wherein the responding step is performed by using an inter-AP communication protocol.

11. A method for sharing radio resource allocation information between access points (APs) in a wireless local area network, comprising the steps of:
reporting resource allocation information from a first AP to a centralized entity;
storing the resource allocation information in the centralized entity;
requesting resource allocation information for the first AP by a second AP, the second AP querying the centralized entity; and
sending resource allocation information for the first AP from the centralized entity to the second AP.

12. The method according to claim 11, wherein the centralized entity is a database.

13. The method according to claim 11, further comprising the step of requesting resource allocation information from the first AP by the centralized entity.

14. A method for sharing radio resource allocation information between access points (APs) in a wireless local area network, comprising the steps of:
reporting resource allocation information from a first AP to a centralized entity;
storing the resource allocation information in the centralized entity; and
relaying the resource allocation information for the first AP from the centralized entity to at least one other AP.

15. The method according to claim 14, wherein the centralized entity is a database.

16. The method according to claim 14, wherein the relaying step includes:
requesting resource allocation information for the first AP by a second AP; and
sending the resource allocation information for the first AP from the centralized entity to the second AP.

17. The method according to claim 14, wherein the relaying step includes:
sending the resource allocation information for the first AP from the centralized entity to all other APs in the network.

18. The method according to claim 14, wherein the relaying step includes:
sending the resource allocation information for the first AP from the centralized entity to other APs that share the wireless medium with the basic service set of the first AP.

19. The method according to claim 14, further comprising the step of requesting resource allocation information from the first AP by the centralized entity.

20. A method for an access controller (AC) to allocate radio resources among access points (APs) in a wireless local area network, comprising the steps of:
reporting radio resource information from an AP to the AC;
storing the resource allocation information in the AC;
requesting radio resources by the AP from the AC; and
responding to the radio resources request by the AC.

21. The method according to claim 20, wherein the radio resource information includes at least one item selected from the group consisting of: a list of stations (STAs) associated to the AP, radio resources that have been allocated to each STA associated to the AP, radio resources that are used by each STA associated to the AP, the aggregated radio resources allocated by the AP, the aggregated radio resources used in a basic service set associated to the AP, and the quality of service experienced by each STA associated to the AP.

22. The method according to claim 20, wherein the requesting step includes requesting an allocated time budget by the AP, the requested time budget based on an association request from a station attempting to associate to the AP.

23. The method according to claim 22, wherein the responding step includes accepting the requested time budget.

24. The method according to claim 22, wherein the responding step includes rejecting the requested time budget.

25. The method according to claim 20, wherein the requesting step includes the AP requesting the amount of radio resources it is allowed to allocate.

26. The method according to claim 25, wherein the responding step includes allocating a time budget to the AP.

27. The method according to claim 20, further comprising the step of requesting resource allocation information from the AP by the centralized entity.
